(19) United States
(12) Patent Application Publication
(10) Pub. No.: US 2014/0194014 A1
(43) Pub. Date: Jul. 10, 2014

(54) ELECTRIC WIRE CONNECTION STRUCTURE

(71) Applicant: FUJI ELECTRIC WIRE INDUSTRIES CO., LTD., Osaka (JP)

(72) Inventors: Kazuhito Inagaki, Osaka (JP); Shinichi Tsujino, Osaka (JP); Masaaki Yamamoto, Osaka (JP); Akira Shibukawa, Osaka (JP)

(73) Assignee: FUJI ELECTRIC WIRE INDUSTRIES CO., LTD., Osaka (JP)

(21) Appl. No.: 14/206,658

(22) Filed: Mar. 12, 2014

Related U.S. Application Data
(63) Continuation of application No. PCT/JP2012/069406, filed on Jul. 31, 2012.

(30) Foreign Application Priority Data
Sep. 12, 2011 (JP) 2011-198129

(51) Int. Cl. H01R 4/02

(52) U.S. Cl. CPC H01R 4/023; H01R 4/027
USPC 439/874

(57) ABSTRACT

The present invention has an object of providing an electric wire connection structure for providing sufficiently high electric characteristics by welding and fixing a terminal and core wires, for providing the terminal with a strength sufficiently high to withstand the pressure at the time of welding, and for improving the adhesiveness of the core wires to the terminal by preventing the core wires from escaping at the time of welding. The electric wire connection structure is for connecting core wires (10) exposed at a tip end of a coated wire (12), including the core wires (10) covered with a insulating cover (11), to a conductive terminal (20). The terminal (20) includes a caulking portion (23) in which the core wires (10) are to be held by caulking, and a welding portion (22) to which the core wires (10) are to be fixed by welding. The caulking portion (23) and the welding portion (22) are arranged in a base portion of the terminal (20) in a longitudinal direction thereof. The welding portion (22) of the terminal (20) includes a positioning portion (24) on which the core wires (10) are to be placed, and holding walls (25), rising upward from an inner bottom surface (24a) of the positioning portion (24), for holding the core wires (10) from both sides thereof at the time of welding. The core wires (10) located in the welding portion) (22) are fixed thereto by welding.

### TECHNICAL FIELD

The present invention relates an electric wire connection structure for connecting core wires exposed at a tip end of a coated wire, including the core wires covered with an insulating cover, to a conductive terminal.

### BACKGROUND ART

A generally known structure for electrically connecting a coated wire, including a plurality of core wires covered with an insulating cover, to a conductive terminal such as a flat blade, a pin-type blade or the like is as follows. The insulating cover is peeled off at a tip end of the coated wire to expose the core wires. The core wires are placed in a caulking portion of the terminal, and the caulking portion is caulked by a pair of dies (anvil and crimper) to be plastically deformed. In this manner, the plurality of core wires are put into pressure contact with the deformed caulking portion.

However, the above-described arrangement of merely putting the core wires into pressure contact with the caulking portion leaves tiny spaces between the caulking portion and the core wires and also among the core wires. This involves a problem that sufficiently high electric characteristics are not provided with certainty.

In order to solve this problem, it is conceivable to perform spot welding as follows. A welding portion is formed in the terminal, at a position in the vicinity of the caulking portion, and the core wires be placed in the welding portion. The welding portion and the core wires (namely, welding subject) are held between a pair of electrodes to be pressurized. An electric current is supplied to the electrodes to fuse the pressurized part by resistance heating. However, such spot welding supplies a high pressure and a large amount of current. Therefore, the terminal needs to have a sufficiently high strength to withstand the pressure. Especially, when a pin-type blade is used as the terminal, the terminal has a problem of not having a strength sufficiently high to withstand the pressure applied at the time of welding because the pin-type blade is formed of free-cutting brass having a relatively high content of lead.

Patent Document 1 discloses the following structure. A cylindrical caulking portion is integrally formed at a base end of a terminal having a circular cross-section, and a plurality of core wires are placed in the caulking portion. The caulking portion is caulked by a pair of, namely, upper and lower, dies to be plastically deformed, so that the plurality of core wires are fixed by caulking.

In the conventional structure disclosed in Patent Document 1, the core wires are merely fixed by caulking. Therefore, there is a problem that sufficiently high electric characteristics are not provided as described above.

### CITATION LIST

### Patent Literature

Patent Document 1: Japanese Laid-Open Patent Publication No. 2000-21543

### SUMMARY OF INVENTION

### Technical Problem

The present invention has an object of providing an electric wire connection structure for providing sufficiently high electric characteristics with certainty by caulking and thus fixing core wires in a caulking portion and welding and thus fixing the core wires and a terminal in a welding portion, for providing the terminal with a strength sufficiently high to withstand the pressure at the time of welding, and for improving the adhesiveness of the core wires to the terminal by preventing the core wires from escaping at the time of welding (namely, from being positionally displaced by the pressure applied by electrodes of a welding device at the time of welding).

### Solution to Problem

The electric wire connection structure according to the present invention is for connecting core wires exposed at a tip end of a coated wire, including the core wires covered with an insulating cover, to a conductive terminal. The terminal includes a caulking portion in which the core wires are to be held by caulking, and a welding portion to which the core wires are to be fixed by welding, the caulking portion and the welding portion being arranged in a base portion of the terminal in a longitudinal direction thereof. The welding portion of the terminal includes a positioning portion on which the core wires are to be placed, and holding walls, rising upward from an inner bottom surface of the positioning portion, for holding the core wires from both sides thereof at the time of welding. The core wires located in the welding portion are fixed thereto by welding.

As the terminal, a pin-type blade or a flat blade may be used.

According to the above-described configuration, the core wires are held in the caulking portion by caulking, and the terminal and the core wires are welded in the welding portion. Therefore, sufficiently high electric characteristics can be provided with certainty. The holding walls provide the terminal with a sufficient strength to withstand the pressure applied at the time of welding. The holding walls also prevent the core wires from escaping at the time of welding and thus improve the adhesiveness of the core wires to the terminal.

In an embodiment according to the present invention, the terminal has a cylindrical shape having a rounded tip obtained as a result of cutting; the positioning portion has a thickness smaller than a diameter of the cylindrical terminal; position restriction portions each having an external shape larger than the diameter of the terminal are provided to the front and rear of, and integrally with, the positioning portion; and the holding walls rise upward from the inner bottom surface of the positioning portion and are provided between, and integrally with, the front and rear position restriction portions.

The position restriction portions may be polygonal, for example, square, hexagonal or the like. The terminal may be a pin-type blade.

According to the above-described configuration, the terminal is allowed to be formed of a material which is easy to cut (for example, free-cutting brass). The welding portion is easily formed by cutting, and also the strength of the terminal (strength of the welding portion) can be improved.

Especially, the holding walls are formed between, and integrally with, the position restriction portions provided to the front and rear thereof and having an external shape larger than the diameter of the terminal. Therefore, even though the positioning portion is formed to be thin in consideration of the welding conditions, the welding walls coupled with the position restriction portions increase the strength of the welding portion. Thus, the welding portion is sufficiently strong to withstand the pressure applied at the time of welding.

In an embodiment according to the present invention, the terminal is formed of a punched flat blade; the positioning portion is formed of a recessed portion which is recessed in the welding portion; and the recessed portion is sandwiched by the holding walls provided on both sides thereof.

The recessed portion may be formed when the terminal is produced by punching, or may be formed by cutting after the terminal is produced by punching.

According to the above-described configuration, the terminal is allowed to be formed of a material suitable to punching (for example, brass). Also in the terminal formed of a flat blade, the holding walls provided on both sides of the recessed portion prevent the core wires from escaping outside and thus improve the adhesiveness of the core wires to the terminal.

In an embodiment according to the present invention, the caulking portion is located at a base end of the terminal, and the welding portion is located immediately to the front of the caulking portion.

The “base end” of the terminal refers to an end of the terminal that is closer to the coated wire.

According to the above-described configuration, the welding portion provides, with certainty, the adhesiveness of the core wires to the terminal, namely, conductivity, and the caulking portion provides a resistance against an external force of pulling the core wires.

Therefore, even if a plug having the above-described electric wire connection structure is, for example, handled roughly and as a result, an external force is applied to the coated wire in a direction of pulling the coated wire, the caulking portion prevents the coated wire from being pulled and thus the adhesiveness of the core wires in the welding portion is maintained.

### Advantageous Effects of Invention

The present invention has an effect of providing sufficiently high electric characteristics with certainty by caulking and thus fixing core wires in a caulking portion and welding and thus fixing the core wires and a terminal in a welding portion, for providing the terminal with a strength sufficiently high to withstand the pressure at the time of welding, and for improving the adhesiveness of the core wires to the terminal by preventing the core wires from escaping at the time of welding.

### BRIEF DESCRIPTION OF DRAWINGS

FIG. 1 is an isometric view of an electric wire connection structure according to the present invention.

FIG. 2 is an isometric view of a terminal.

FIG. 3(a) is a side view of the terminal, and FIG. 3(b) is a cross-sectional view of the terminal taken along a plane in a longitudinal direction thereof.

FIG. 4(a) is a left side view of FIG. 3(a),

FIG. 4(b) is a right side view of FIG. 3(b), and FIG. 4(c) is a cross-sectional view of the terminal taken along line A-A in FIG. 3(a).

FIG. 5(a) is an exploded view of the terminal and a coated wire, and FIG. 5(b) is a cross-sectional view of the terminal having the core wires located therein.

FIG. 6(a) is a cross-sectional view of the terminal showing a state where the core wires are held in a caulking portion by caulking, and FIG. 5(b) is a cross-sectional view of the terminal taken along line B-B in FIG. 6(a).

FIG. 7(a) is a cross-sectional view of the terminal showing a state where the core wires are fixed in a welding portion by welding, and FIG. 7(b) is a cross-sectional view of the terminal taken along line C-C in FIG. 7(a).

FIG. 8 shows, in comparison, the changes in the contact resistance value of an example product and a comparative product during elapse of the heating time.

FIG. 9 shows, in comparison, the changes in the temperature rise of the example product and the comparative product when an electric current is supplied thereto.

FIG. 10 shows, in comparison, the changes in the temperature rise of the example product and the comparative product when an electric current is supplied thereto.

FIG. 11 shows, in comparison, the changes in the temperature rise of the example product and the comparative product with respect to the number of ON/OFF cycles of supply of an electric current.

FIG. 12 is a cross-sectional view of a plug showing an example in which the electric wire connection structure is used.

FIG. 13(a) is an isometric view of a flat blade, FIG. 13(b) is a cross-sectional view showing a recessed portion shown in FIG. 13(a), and FIG. 13(c) is cross-sectional view of a recessed portion in another example.

FIG. 14(a) is a cross-sectional view showing a state where the core wires are fixed in the recessed portion shown in FIG. 13(b) by welding, and FIG. 14(b) is a cross-sectional view showing a state where the core wires are fixed in the recessed portion shown in FIG, 13(c) by welding.

### DESCRIPTION OF EMBODIMENTS

The objects of providing sufficiently high electric characteristics, providing a terminal with a strength sufficiently high to withstand the pressure at the time of welding, and improving the adhesiveness of core wires to the terminal by preventing the core wires from escaping at the time of welding are realized by an electric wire connection structure for connecting the core wires exposed at a tip end of a coated wire, including the core wires covered with an insulating cover, to the conductive terminal, wherein the terminal includes a caulking portion in which the core wires are to be held by caulking, and a welding portion to which the core wires are to be fixed by welding, the caulking portion and the welding portion being arranged in a base portion of the terminal in a longitudinal direction thereof; the welding portion of the terminal includes a positioning portion on which the core wires are to be placed, and holding walls, rising upward from an inner bottom surface of the positioning portion, for holding the core wires from both sides thereof at the time of welding; and the core wires located in the welding portion are fixed thereto by welding.

### EXAMPLE

Hereinafter, an example of the present invention will be described in detail with reference to the drawings.

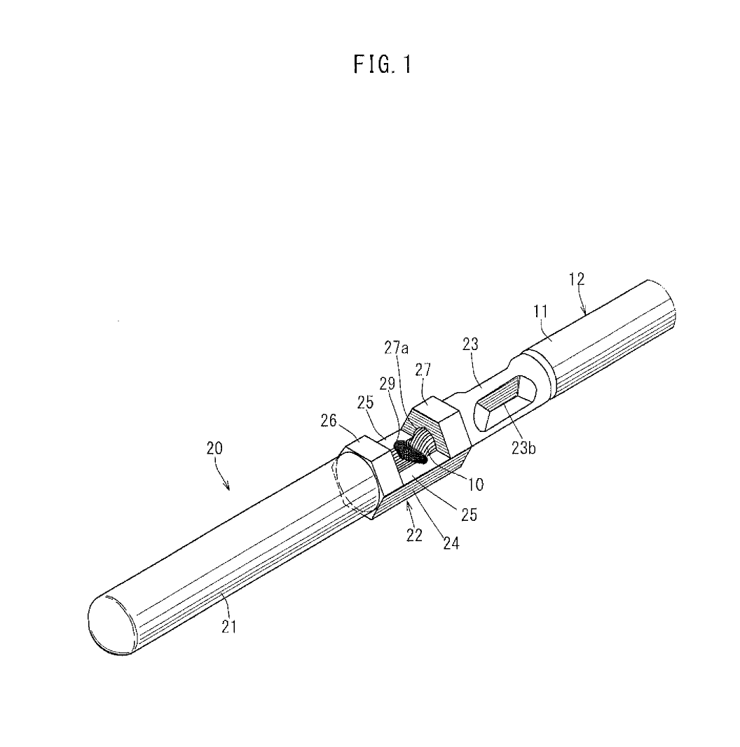

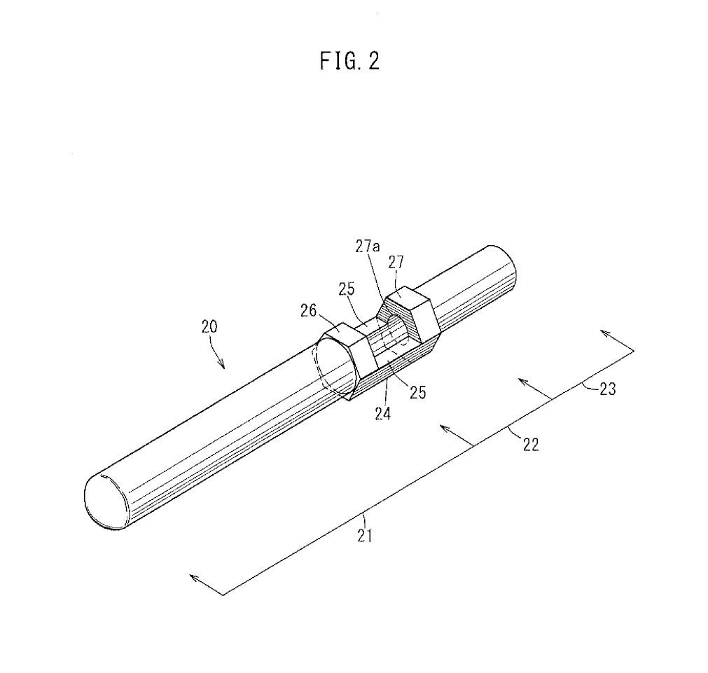

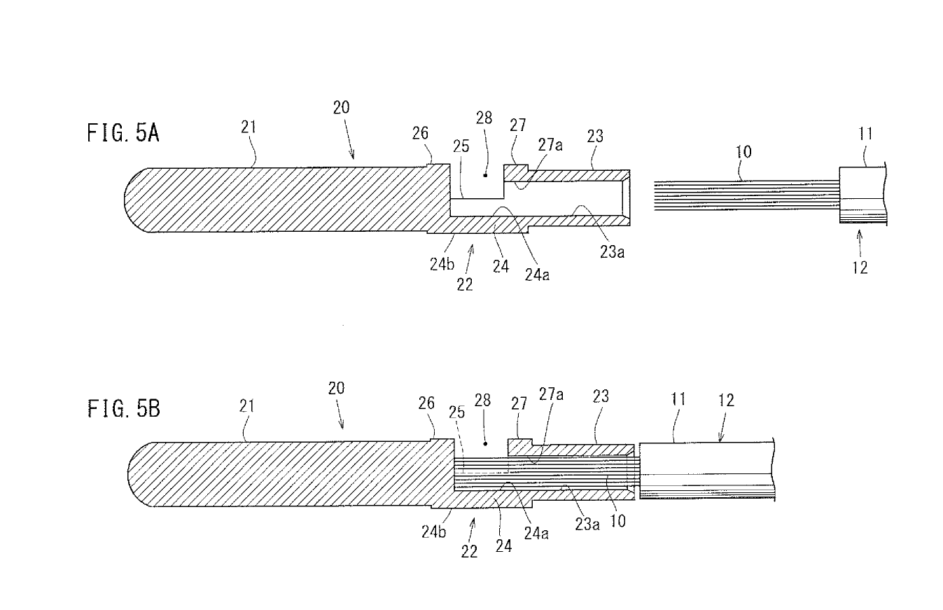

The drawings show an electric wire connection structure. FIG. 1 is an isometric view showing the electric wire connection structure. A coated wire 12 (see FIG. 5(a)) includes a plurality of core wires 10 covered with an insulating cover 11. The insulating cover 11 is peeled off at a tip end of the coated wire 12 to expose the core wires 10, and the exposed part of the core wires 10 is connected to a conductive terminal 20 (see FIG. 2).

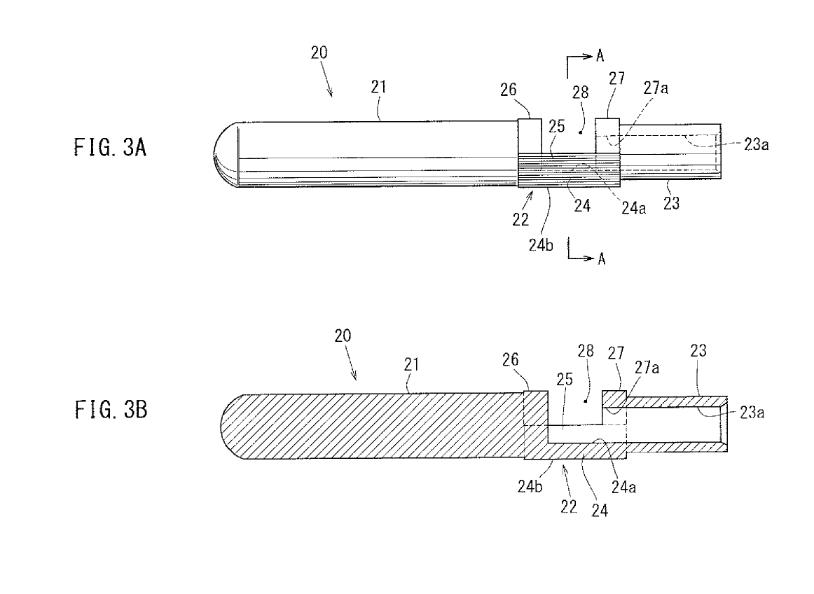

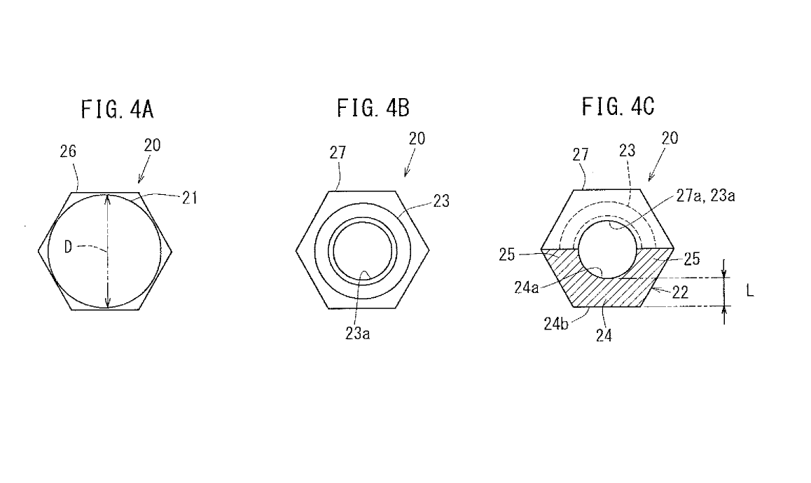

FIG. 2 is an isometric view of the terminal. FIG. 3(a) is a side view of the terminal, and FIG. 3(b) is a cross-sectional view of the terminal taken along a plane in a longitudinal direction thereof. FIG. 4(a) is a left end view of FIG. 3(a). FIG. 4(b) is a right end view of FIG. 3(a). FIG. 4(c) is a cross-sectional view of the terminal taken along line A-A in FIG. 3(a).

As shown in FIG. 2 through FIG. 4, the terminal 20 is formed of a pin-type blade and includes a solid cylindrical terminal portion 21 extending between a tip end (left end as shown in FIG. 2) and a base end (right end as shown in FIG. 2) and having a rounded tip, a welding portion 22 to which the core wires 10 are to be fixed by welding, a cylindrical (so-called pipe-shaped) caulking portion 23 in which the core wires 10 are to be held by caulking. The terminal portion 21, the welding portion 22 and the caulking portion 23 are formed integrally by cutting.

This will be described more specifically. The caulking portion 23 in which the core wires 10 are to be held by caulking and the welding portion 22 to which the core wires 10 are to be fixed by welding are provided in a base portion of the terminal 20 and are arranged in the longitudinal direction thereof. In this example, as shown in FIG. 2 and FIG. 3, the caulking portion 23 is located at the base end, and the welding portion 22 is located immediately to the front of the caulking portion 23.

The terminal 20 is formed of, for example, free-cutting brass (containing Pb at 1.8 to 3.7% by weight) defined by JIS C3601.

As shown in FIG. 3 and FIG. 4, the welding portion 22 of the terminal 20 includes a positioning portion 24 which is located in a bottom part of the welding portion 22 and on which the core wires 10 are to be placed, and a pair of holding walls 25 rising upward from an inner bottom surface 24a of the positioning portion 24. The pair of holding walls 25 holds, as wrapping from both sides, the plurality of core wires 10 so that the plurality of core wires 10 do not escape outside at the time of welding.

As shown in FIG. 4, the positioning portion 24 has a thickness L which is smaller than a diameter D of the solid cylindrical terminal portion 21 (i.e., L<D). An outer bottom surface 24b of the positioning portion 24 is formed to be flat in consideration of various conditions for welding.

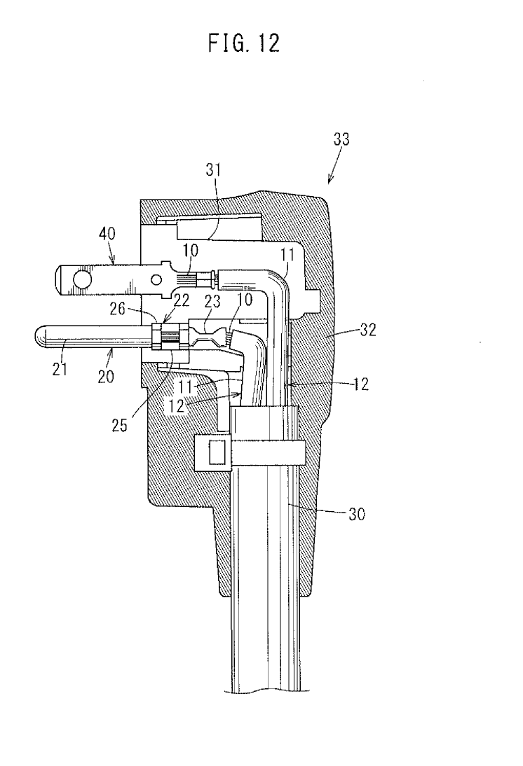

As shown in FIG. 3, hexagonal position restriction portions 26 and 27, each having an external shape larger than the diameter D of the terminal portion 21, are provided to the front and rear of the positioning portion 24. The pair of holding walls 25 rise upward from the inner bottom surface 24a of the positioning portion 24 and are formed between, and integrally with, the position restriction portions 26 and 27. The position restriction portions 26 and 27 restrict the position of the terminal 20 in a front-rear direction and a left-right direction when the terminal 20 is assembled with an insert member 31 shown in FIG. 12.

The position restriction portion 26 provided on the front side has a hexagonal shape having no through-hole at a center thereof, whereas the position restriction portion 27 provided on the rear side has a through-hole 27a at a center thereof so that the core wires 10 can be inserted therethrough.

As shown in FIG. 3(b) and FIG. 4(c), an inner surface of the caulking portion 23 defining a through-hole 23a, an inner surface of the hexagonal rear position restriction portion 27 defining the through-hole 27a, the inner bottom surface 24a of the positioning portion 24, and inner circumferential surfaces of the holding walls 25 are formed so as to be continuous in the front-rear direction with no step being formed.

Owing to such a continuous configuration, the core wires 10 can be inserted into the through-hole 23a of the caulking portion 23 and the through-hole 27a of the rear position restriction portion 27 without being caught by anything and thus can be placed smoothly on the inner bottom surface 24a of the positioning portion 24. Thus, the operability of positioning the core wires 10 can be improved.

The holding walls 25 each have a height that is about half the height of each of the front and rear position restriction portions 26 and 27. In addition, the pair of holding walls 25 and the positioning portion 24 have an outer side surface aligned with the shape of the hexagonal position restriction portions 26 and 27, such that the holding walls 25 and the positioning portion 24 do not protrude outer to the outer surface of the position restriction portions 26 and 27.

The flat outer bottom surface 24b of the positioning portion 24 and one surface of each of the hexagonal position restriction portions 26 and 27 are formed to be continuous in the front-rear direction.

In addition, a space 28 is formed above the holding walls 25 between the front and rear position restriction portions 26 and 27. In the space 28, an upper electrode is located at the time of spot welding.

Now, with reference to FIG. 5(a) through FIG. 7(b), a method for connecting the core wires 10 of the coated wire 12 to the terminal 20 will be described.

First, as shown in FIG. 5(a), the exposed part of the core wires 10 at the tip end of the coated wire 12 is placed to face the through-hole 23a of the caulking portion 23 of the terminal 20. Next, as shown in FIG. 5(b), the core wires 10 are placed on the positioning portion 24 through the through-hole 23a of the caulking portion 23 and the through-hole 27a of the hexagonal rear position restriction portion 27.

For placing the core wires 10 on the inner bottom surface 24a of the positioning portion 24 through the through-holes 23a and 27a, the exposed tip part of the core wires 10 may be put into contact with a rear surface of the hexagonal front position restriction portion 26 as shown in FIG. 5(b).

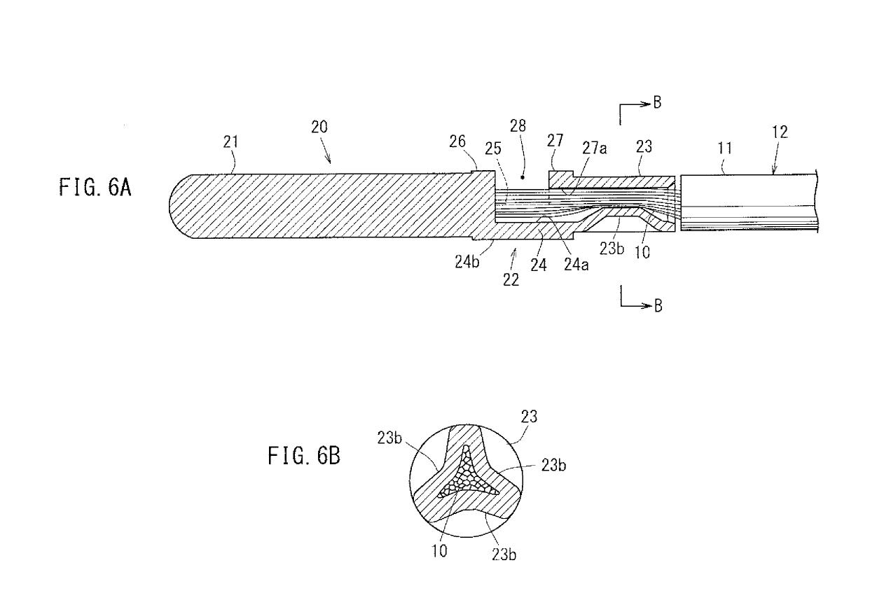

Next, in the state shown in FIG. 5(b), the caulking portion 23 of the terminal 20 is caulked by use of a caulking device (not shown). As a result, the core wires 10 are fixed to the caulking portion 23 as shown in FIGS. 6(a) and 6(b).

In this example, as shown in FIG. 6(b), the caulking portion 23 is plastically deformed until three recessed portions 23b which are recessed inward in a radial direction of the caulking portion 23 are formed at an equal interval of 120 degrees. The plurality of core wires 10 are held by the three recessed portions 23b. In this state, even when an external force acts on the coated wire 12 in a direction of pulling the core wires 10, the caulking portion 23 can prevent the core wires 10 from being pulled.

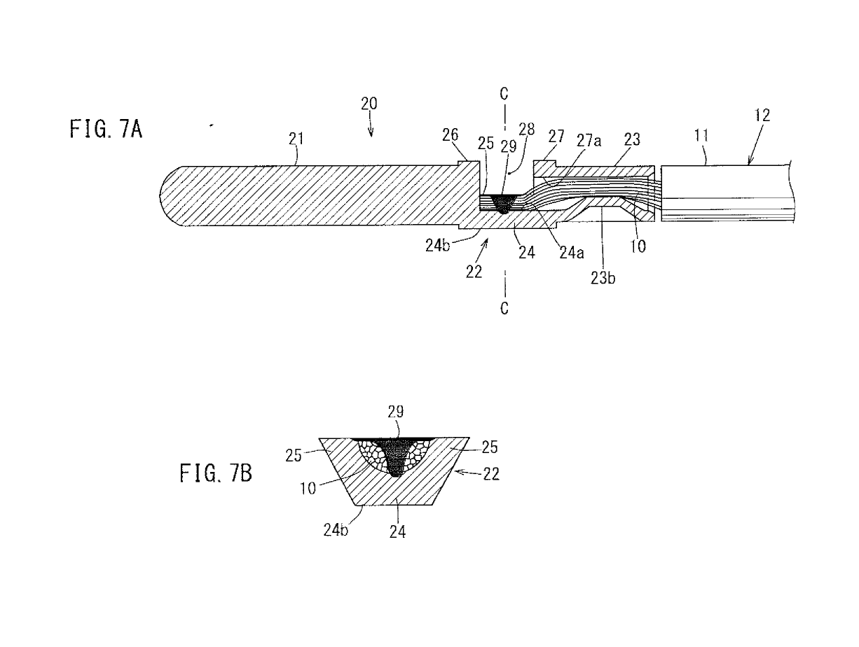

Next, after the caulking, spot welding is performed as shown in FIG. 7. The welding portion 22 and the core wires 10 (i.e., welding subject) are held between a pair of, namely, upper and lower, electrodes of a spot welding device (not shown) and are pressurized. An electric current is supplied to fuse the pressurized part by resistance heating. As a result, as shown in FIGS. 7(a) and 7(b), a fused portion 29 (so-called nugget; painted black in the figures for the sake of convenience) is formed in the welding portion 22 and the core wires 10. Such welding can provide sufficiently high electric characteristics with certainty. For the spot welding, the core wires 10 located above the pair of holding walls 25 are pushed into the space between the pair of holding walls 25 by the upper electrode or a spot welding jig.

For the spot welding, a high pressure and a large amount of electric current are supplied. The pair of holding walls 25 provided in the welding portion 22 increase the strength of the welding portion 22. Therefore, even when the terminal 20 is formed of free-cutting brass, which contains lead, the terminal 20 can be prevented from being bent and deformed by the pressure applied at the time of welding.

For the spot welding, the plurality of core wires 10 are held, as being wrapped, by the pair of holding walls 25 rising upward from the inner bottom surface 24a of the positioning portion 24. Therefore, even when being pressurized by the upper spot welding electrode, the core wires 10 are not displaced outward, namely, do not escape outside. This improves the adhesiveness of the plurality of core wires 10 to the terminal 20.

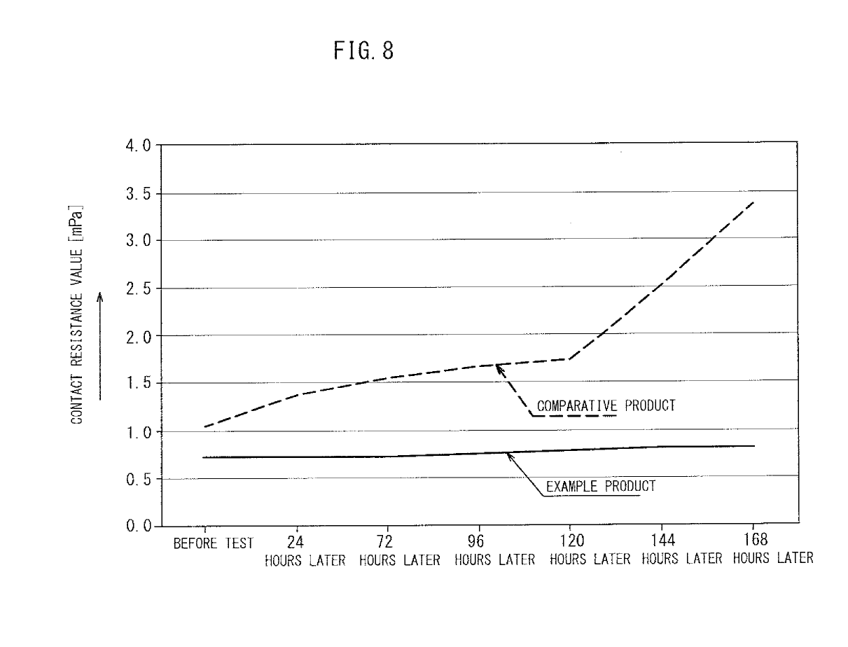

Aside from the example product shown in FIG. 7, a comparative product was produced by use of the caulking pressure-contact process. The welding process was not used. Various tests were performed on the example product and the comparative example. FIG. 8 through FIG. 11 show the characteristics thereof found by the measurement results in comparison with each other.

FIG. 8 shows the contact resistance value found as follows. The terminals were heated at a temperature of 100° C., and the contact resistance value of the terminals and the core wires were measured at various points in time during the heating. It is made clear that the contact resistance of the example product is kept at substantially the same level even after a certain heating time period elapses, whereas the contact resistance of the comparative product is raised excessively along with the elapse of the heating time.

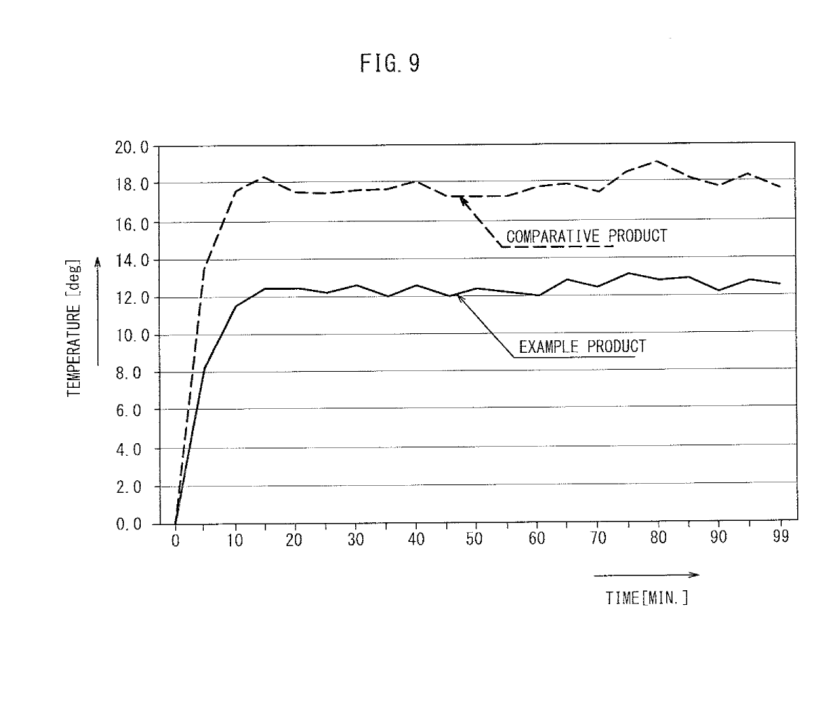

FIG. 9 shows the characteristics found as follows. The core wires were supplied with an electric current of 19.2 amperes, and the temperature rise was measured. The horizontal axis represents the time period in which the electric current flows, and the vertical axis represents the temperature rise of the terminal. It is made clear that the temperature rise is suppressed lower in the example product than in the comparative product.

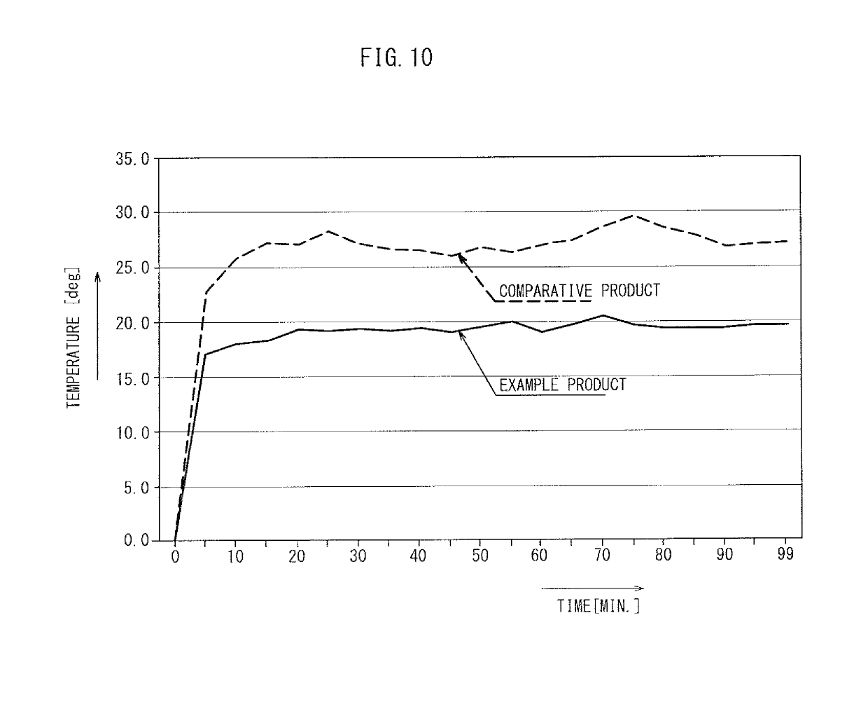

FIG. 10 shows the characteristics found as follows. The core wires were supplied with an electric current of 24 amperes, and the temperature rise was measured. Like in FIG. 9, the horizontal axis represents the time period in which the electric current flows, and the vertical axis represents the temperature rise of the terminal. The temperature rise is suppressed lower in the example product than in the comparative product.

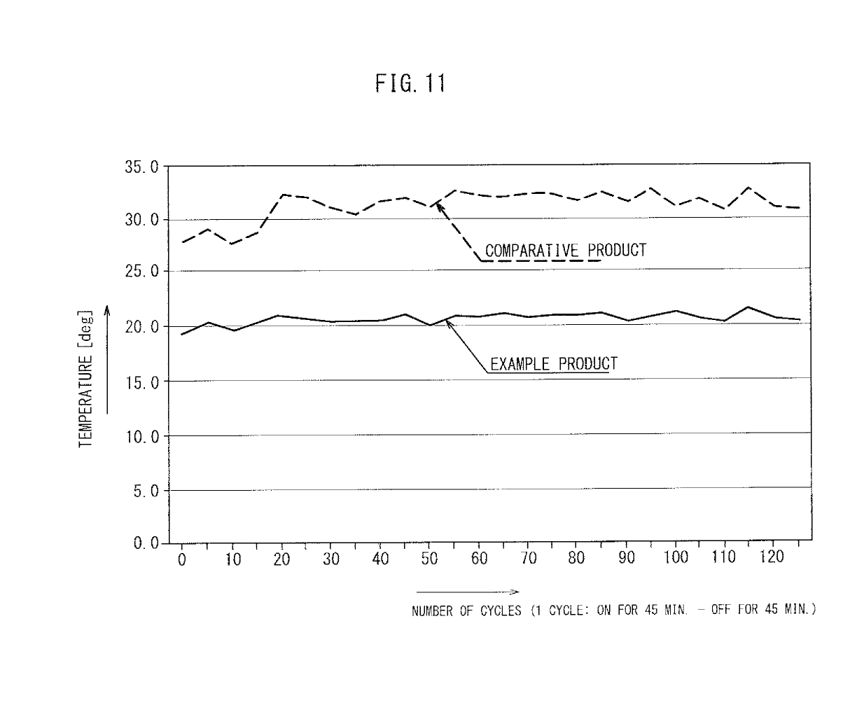

FIG. 11 shows the characteristics found as follows.

The core wires were supplied with an electric current of 24 amperes for 45 minutes, and then the supply of the electric current was paused for 45 minutes. This supply-pause cycle was repeated. The horizontal axis represents the number of cycles, and the vertical axis represents the temperature rise of the terminal (FIG. 11 shows the so-called heat cycle results). It is made clear that the temperature rise is suppressed lower in the example product than in the comparative product.

As is clear from FIG. 8 through FIG. 11, in the example product, the contact resistance did not change much regardless of the heating time, and the temperature rise by the supply of the electric current was suppressed sufficiently low.

As described above, the electric wire connection structure in this example shown in FIG. 1 through FIG. 7 is an electric wire connection structure for connecting the core wires 10 exposed at a tip end of the coated wire 12, including the core wires 10 covered with the insulating cover 11, to the conductive terminal 20. The terminal 20 includes the caulking portion 23 in which the core wires 10 are to be held by caulking, and the welding portion 22 to which the core wires 10 are to be fixed by welding. The caulking portion 23 and the welding portion 22 are arranged in a base portion of the terminal 20 in the longitudinal direction thereof. The welding portion 22 of the terminal 20 includes the positioning portion 24 on which the core wires 10 are to be placed, and the holding walls 25, rising upward from the inner bottom surface 24a of the positioning portion 24, for holding the core wires 10 from both sides thereof at the time of welding. The core wires 10 located in the welding portion 22 are fixed thereto by welding (see FIG. 7).

According to this configuration, the terminal 20 and the core wires 10 are welded. Therefore, sufficiently high electric characteristics can be provided with certainty. The holding walls 25 provide the terminal with a sufficient strength to withstand the pressure applied at the time of welding. The holding walls 25 also prevent the core wires 10 from escaping at the time of welding and thus improve the adhesiveness of the core wires 10 to the terminal 20.

The terminal 20 has a cylindrical shape having a rounded tip obtained as a result of cutting. The positioning portion 24 is formed to have a thickness smaller than the diameter D of the cylindrical terminal 20. The position restriction portions 26 and 27, each having an external shape larger than the diameter D of the terminal 20, are formed to the front and rear of the positioning portion 24. The holding walls 25 rise upward from the inner bottom surface 24a of the positioning portion 24 and are formed between, and integrally with, the front and rear position restriction portions 26 and 27 (see FIG. 1, FIG. 4 and FIG. 7).

According to this configuration, the terminal 20 is allowed to be formed of a material which is easy to cut. The welding portion 22 is easily formed by cutting, and also the strength of the terminal (strength of the welding portion 22) can be improved.

Especially, the holding walls 25 are formed between, and integrally with, the position restriction portions 26 and 27 provided to the front and rear thereof and having an external shape larger than the diameter of the terminal 20. Therefore, even though the positioning portion 24 is formed to be thin in consideration of the welding conditions, the welding walls 25 coupled with the position restriction portions 26 and 27 increase the strength of the welding portion 22. Thus, the welding portion 22 is sufficiently strong to withstand the pressure applied at the time of welding.

The caulking portion 23 is located at the base end of the terminal 20, and the welding portion 22 is formed immediately to the front of the caulking portion 23 (see FIG. 7).

The “base end” of the terminal 20 refers to an end of the terminal 20 that is closer to the coated wire 12.

According to this configuration, the welding portion 22 provides, with certainty, the adhesiveness of the core wires 10 to the terminal 20, namely, conductivity, and the caulking portion 23 provides a resistance against an external force of pulling the core wires 10.

Therefore, even if a plug having the above-described electric wire connection structure is, for example, handled roughly and as a result, an external force is applied to the coated wire 12 in a direction of pulling the coated wire 12, the caulking portion 23 prevents the coated wire 12 from being pulled and thus the adhesiveness of the core wires in the welding portion 22 is maintained.

FIG. 12 shows an example in which the electric wire connection structure shown in FIG. 1 through FIG. 7 is used. The terminal 20 formed of a pin-type blade is connected to the coated wire 12. Two terminals 40 which are each formed of a flat blade (only one is shown for the sake of convenience) are connected to coated wires 12. A total of three coated wires 12 are covered with an insulating cover to form a cord 30. The base portion of the terminal portion 21 and the welding portion 22 of the terminal 20 formed of a pin-type blade, and base portions of the type terminals 40 each formed of a flat blade are assembled to the insert member 31 formed of a thermosetting plastic material such as a melamine resin or the like. Then, these elements shown in the figure are integrated with a plug body 32 formed of a thermoplastic material such as poly (vinyl) chloride or the like. Thus, a plug 33 usable for charging an electric automobile is formed.

FIG. 12 shows a mere example in which the electric wire connection structure is usable. The electric wire connection structure shown in FIG. 1 through FIG. 7 is applicable to any of various types of plugs, needless to say.

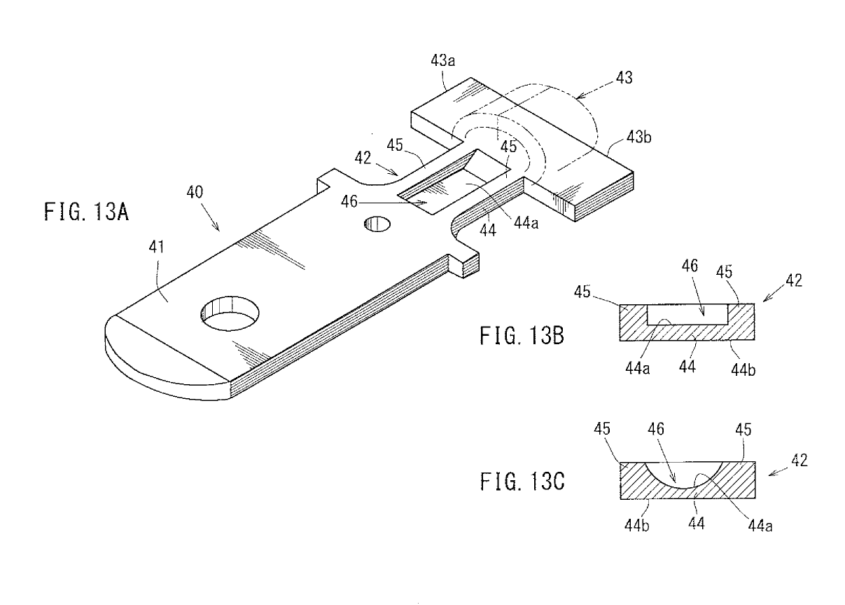

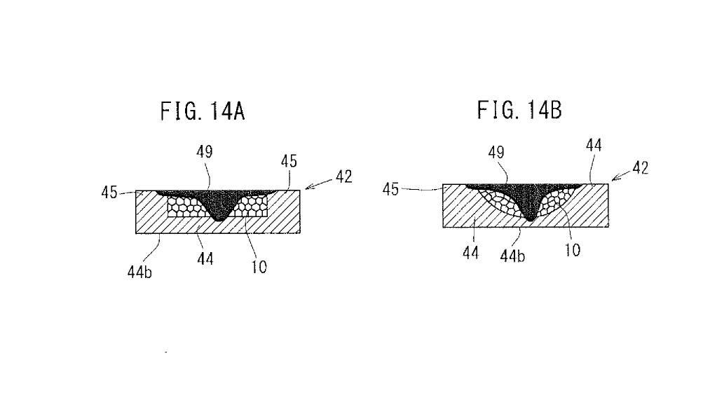

The present invention is applicable to the terminal 20 formed of a pin-type blade shown in FIG. 1 through FIG. 7 and also to the terminal 40 formed of a flat blade shown in FIG. 12. Hereinafter, an example in which the present invention is applied to the terminal 40 formed of a flat blade will be described with reference to FIG. 13 and FIG. 14.

FIG. 13(a) is an isometric view of the terminal formed of a flat blade, and FIG. 13(b) is a cross-sectional view of a welding portion shown in FIG. 13(a). FIG. 13(c) is a cross-sectional view of a welding portion in another example. FIG. 14(a) is a cross-sectional view showing a welded and fixed state of core wires and corresponds to FIG. 13(b) FIG. 14(b) is a cross-sectional view showing a welded and fixed state of core wires and corresponds to FIG. 13(c).

As shown in FIG. 13, the terminal 40 is formed of a flat blade, and includes a flat terminal portion 41, a welding portion 42 to which the core wires 10 (see FIG. 12) are to be fixed by welding, and a caulking portion 43 including caulking pieces 43a and 43b which are to be caulked to hold the core wires 10. These elements are provided in an area from a tip end (left end as shown in FIG. 13(a)) to a base end (right end as shown in FIG. 13(a)) of the terminal 40, and are integrally formed by punching.

This will be described more specifically. The caulking portion 43 in which the core wires 10 are to be held by caulking and the welding portion 42 to which the core wires 10 are to be fixed by welding are provided in a base portion of the terminal 40 and are arranged in a longitudinal direction thereof. In this example, as shown in FIG. 13(a), the caulking portion 43 is located at the base end of the terminal 40, and the welding portion 42 is located immediately to the front of the caulking portion 43.

The terminal 40 is formed of, for example, brass (containing Cu at 64.0 to 68.0% by weight and Pb at a very low content of 0.05% by weight or less) defined by JIS 02680.

As shown in FIG. 13(b), the welding portion 42 of the terminal 40 includes a positioning portion 44 which is located in a bottom part of the welding portion 42 and on which the core wires 10 are to be placed, and a pair of holding walls 45 rising upward from an inner bottom surface 44a of the positioning portion 44. The pair of holding walls 45 holds, as wrapping from both sides, the plurality of core wires 10 so that the plurality of core wires 10 do not escape outside at the time of welding.

In this example, the positioning portion 44 is formed of a recessed portion 46 which is recessed in the welding portion 42. The recessed portion 46 is sandwiched by the holding walls 45 on both sides thereof.

The recessed portion 46 may be recessed to have a cornered cross-sectional shape as shown in FIG. 13(b) or may be recessed to have a semicircular cross-sectional shape like a groove as shown in FIG. 13(c).

In this example also, the positioning portion 44 has a flat outer bottom surface 44b.

The exposed part of the core wires 10 at the tip end of the coated wire 12 is placed in the welding portion 42 and the caulking portion 43 of the terminal 40. The pair of caulking pieces 43a and 43b of the caulking portion 43 are caulked to fix the plurality of core wires 10. Then, spot welding is performed. The welding portion 42 and the core wires 10 (i.e., welding subject) are held between a pair of, namely, upper and lower, electrodes of a spot welding device (not shown) and are pressurized. An electric current is supplied to fuse the pressurized part by resistance heating. As a result, as shown in FIG. 14, a fused portion 49 (so-called nugget; painted black in the figures for the sake of convenience) is formed in the welding portion 42 and the core wires 10. Such welding can provide high electric characteristics with certainty. For the spot welding, the core wires 10 located above the pair of holding walls 45 are pushed into the space between the pair of holding walls 45, namely, into the recessed portion 46, by the upper electrode or a spot welding jig.

As described above, the electric wire connection structure in this example shown in FIG. 13 and FIG. 14 is an electric wire connection structure for connecting core wires 10 exposed at a tip end of the coated wire 12, including the core wires 10 covered with the insulating cover 11, to the conductive terminal 40. The terminal 40 includes the caulking portion 43 in which the core wires 10 are to be held by caulking, and the welding portion 42 to which the core wires 10 are to be fixed by welding. The caulking portion 43 and the welding portion 42 are arranged in a base portion of the terminal 40 in a longitudinal direction thereof. The welding portion 42 of the terminal 40 includes the positioning portion 44 on which the core wires 10 are to be placed, and the holding walls 45, rising upward from the inner bottom surface 44a of the positioning portion 44, for holding the core wires 10 from both sides thereof at the time of welding. The core wires 10 located in the welding portion 42 are fixed thereto by welding (see FIG. 13 and FIG. 14).

According to this configuration, the core wires 10 are held in the caulking portion 43 by caulking, and the terminal 40 and the core wires 10 are welded in the welding portion 42. Therefore, sufficiently high electric characteristics can be provided with certainty. The holding walls 45 provide the terminal with a sufficient strength to withstand the pressure applied at the time of welding. The holding walls 45 also prevent the core wires 10 from escaping at the time of welding and thus improve the adhesiveness of the core wires 10 to the terminal 40.

The terminal 40 is formed of a flat blade produced as a result of punching. The positioning portion 44 is formed of the recessed portion 46 recessed in the welding portion 42 and sandwiched by the holding walls 45 on both of sides thereof (see FIG. 13).

The recessed portion 46 maybe formed when the terminal 40 is produced by punching, or may be formed by cutting after the terminal 40 is produced by punching.

According to this configuration, the terminal 40 is allowed to be formed of a material suitable to punching (for example, brass). Also in the terminal 40 formed of a flat blade, the holding walls 45 provided on both sides of the recessed portion 46 prevent the core wires 10 from escaping outside and thus improve the adhesiveness of the core wires 10 to the terminal 40.

The caulking portion 43 is located at the base end of the terminal 40, and the welding portion 42 is formed immediately to the front of the caulking portion 43 (see FIG. 13(a)).

According to this configuration, the welding portion 42 provides, with certainty, the adhesiveness of the core wires 10 to the terminal 40, namely, the conductivity, and the caulking portion 43 provides a resistance against an external force of pulling the core wires 10.

Therefore, even if a plug having the above-described electric wire connection structure is, for example, handled roughly and as a result, an external force is applied to the coated wire 12 in a direction of pulling the coated wire 12, the caulking portion 43 prevents the coated wire 12 from being pulled and thus the adhesiveness of the core wires in the welding portion 42 is maintained.

### INDUSTRIAL APPLICABILITY

As described above, the present invention is useful for an electric wire connection structure for connecting core wires exposed at a tip end of a coated wire, including the core wires covered with an insulating cover, to a conductive terminal.

### REFERENCE SIGNS LIST

10 . . . Core wire

11 . . . Insulating cover

12 . . . Coated wire

20, 40 . . . Terminal

22, 42 . . . Welding portion

23, 43 . . . Caulking portion

24, 44 . . . Positioning portion

24a, 44a . . . Inner bottom surface

25, 45 . . . Holding wall

26, 27 . . . Position restriction portion

46 . . . Recessed portion

1. An electric wire connection structure for connecting core wires exposed at a tip end of a coated wire, including the core wires covered with an insulating cover, to a conductive terminal, wherein:
the terminal includes:
a caulking portion in which the core wires are to be held by caulking,
and a welding portion to which the core wires are to be fixed by welding,
the caulking portion and the welding portion being arranged in a base portion of the terminal in a longitudinal direction thereof;
the welding portion of the terminal includes:
a positioning portion on which the core wires are to be placed, and
holding walls, rising upward from an inner bottom surface of the positioning portion, for holding the core wires from both sides thereof at the time of welding; and
the core wires located in the welding portion are fixed thereto by welding.

2. An electric wire connection structure according to claim 1, wherein:
the terminal has a cylindrical shape having a rounded tip obtained as a result of cutting;
the positioning portion has a thickness smaller than a diameter of the cylindrical terminal;
position restriction portions each having an external shape larger than the diameter of the terminal are provided to the front and rear of, and integrally with, the positioning portion; and
the holding walls rise upward from the inner bottom surface of the positioning portion and are provided between, and integrally with, the front and rear position restriction portions.

3. An electric wire connection structure according to claim 1, wherein:
the terminal is formed of a punched flat blade;
the positioning portion is formed of a recessed portion which is recessed in the welding portion; and
the recessed portion is sandwiched by the holding walls provided on both sides thereof.

4. An electric wire connection structure according to any one of claims 1 through 3, wherein the caulking portion is located at a base end of the terminal, and the welding portion is located immediately to the front of the caulking portion.
